(19) United States
(12) Patent Application Publication
(10) Pub. No.: US 2008/0105665 A1
(43) Pub. Date: May 8, 2008

(54) Laser processing machine

(75) Inventor: Koichi Kondo, Ota-ku (JP)

Correspondence Address: GREER, BURNS & CRAIN, 300 S WACKER DR, 25TH FLOOR, CHICAGO, IL, 60606, US

(73) Assignee: Disco Corporation, Tokyo (JP)

(21) Appl. No.: 11/982,598

(22) Filed: Nov. 2, 2007

(30) Foreign Application Priority Data
Nov. 2, 2006 (JP) 2006-298435

(51) Int. Cl. B23K 26/067; B23K 26/073

(52) U.S. Cl. 219/121.77; 219/121.73

(57) ABSTRACT

A laser processing machine is provided which includes a chuck table adapted to hold a workpiece; and a laser beam irradiation unit for emitting a laser beam to the workpiece held by the chuck table. The laser beam irradiation unit includes a single laser beam oscillating unit for emitting a laser beam; a beam splitter which splits the laser beam emitted from the laser beam oscillating unit into a first laser beam propagating along a first path and a second laser beam propagating along a second path; a first condenser which condenses the first laser beam; and a second condenser which condenses the second laser beam.

### BACKGROUND OF THE INVENTION

1. Field of the Invention

The present invention relates to a laser processing machine that can perform two different types of laser processing on a workpiece.

2. Description of the Related Art

In the semiconductor manufacturing process, an almost-disklike semiconductor wafer is sectioned on its front surface by predetermined diving lines called streets arranged in a lattice-like pattern into a plurality of areas, on which devices such as ICs, LSIs or the like are formed. There is known a semiconductor wafer that is partially formed on streets with test-purpose metal patterns called test element groups (TEG) used to test the functions of devices. Such a semiconductor wafer is cut along the streets to divide the areas formed with the devices into individual semiconductor chips for manufacture. Also an optical device wafer in which a light-receiving element such as a photo diode or the like or a light-emitting element such as a laser diode or the like are laminated on the front surface of a sapphire substrate is cut along streets to be divided into individual optical devices such as photo diodes or laser diodes, which are widely used in electrical equipment.

The following method is proposed as a method of dividing a wafer such as the semiconductor wafer, the optical device wafer or the like described above along streets. A pulse laser beam with a wavelength having absorbency for the wafer is emitted along the streets of the wafer to form laser processing grooves. Then, the wafer is divided along the laser processing grooves. See e.g. Japanese Patent Laid-Open No. 2004-9139.

However, in the semiconductor wafer partially formed with the test-purpose metal patterns called test element groups (TEG) used to test the functions of devices on the street, it is not possible to form a uniform laser processing groove even if the pulse laser beam is emitted along the associated street. Thus, it is necessary to apply a pulse laser beam along streets after a pulse laser beam is applied to an area where a metal pattern such as copper and aluminum is present, to remove the metal pattern. In such laser processing, when the metal pattern is removed, it is preferable that the light focusing spot of the laser beam should be formed in a circle, which is high in light focusing density. When the laser processing groove is formed, it is preferable that the light focusing spot should be formed in an oval, which is large in overlap ratio.

In order to perform two types of laser processing on a workpiece as described above, it is necessary to use two laser processing machines or to provide two laser beam irradiation means for one laser processing machine. However, since a laser oscillator constituting the laser beam irradiation means is expensive, providing respective laser oscillators for two laser beam irradiation means significantly increases the cost of the laser processing machine.

### SUMMARY OF THE INVENTION

It is, therefore, an object of the present invention to provide a laser processing machine equipped with laser beam irradiation means in which a single laser oscillator can provide two kinds of laser processing.

In accordance with an aspect of the present invention, there is provided a laser processing machine including: a chuck table adapted to hold a workpiece; and laser beam irradiation means for emitting a laser beam to the workpiece held by the chuck table; wherein the laser beam irradiation means includes: single laser beam oscillating means for emitting a laser beam; a beam splitter which splits the laser beam emitted from the laser beam oscillating means into a first laser beam propagating along a first path and a second laser beam propagating along a second path; a first condenser which condenses the first laser beam; and a second condenser which condenses the second laser beam.

Preferably, a first acousto-optic deflection means for deflecting the first laser beam is disposed in the first path and a second acousto-optic deflection means for deflecting the second laser beam is disposed in the second path. In addition, a spot on which the first laser beam is focused by the first condenser is different in shape from a spot on which the second laser beam is focused by the second condenser.

According to the present invention, the laser beam irradiation means includes the single laser beam oscillating means for emitting a laser beam; the beam splitter which splits the laser beam emitted from the laser beam oscillating means into a first laser beam propagating along the first path and a second laser beam propagating along the second path; the first condenser which condenses the first laser beam; and the second condenser which condenses the second laser beam. Therefore, the laser beam irradiation means provided with the single pulse laser beam oscillating means can perform two different kinds of laser processing on the workpiece held by the chuck table.

The above and other object, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser processing machine constructed according to the present invention;

FIG. 2 is a block diagram of laser beam irradiation means provided for the laser processing machine shown in FIG. 1;

FIG. 3 is a perspective view of a semiconductor wafer as a workpiece;

FIG. 4 is a perspective view illustrating a state in which the semiconductor wafer of FIG. 3 is stuck on the front surface of a protection tape attached to an annular frame;

FIGS. 5A and 5B are views for assistance in explaining a metal pattern removal step performed by the laser processing machine shown in FIG. 1; and

FIGS. 6A and 6B are views for assistance in explaining a laser processing groove formation step performed by the laser processing machine shown in FIG. 1.

### DETAILED DESCRIPTION OF THE PREFERRED EMBODIMENTS

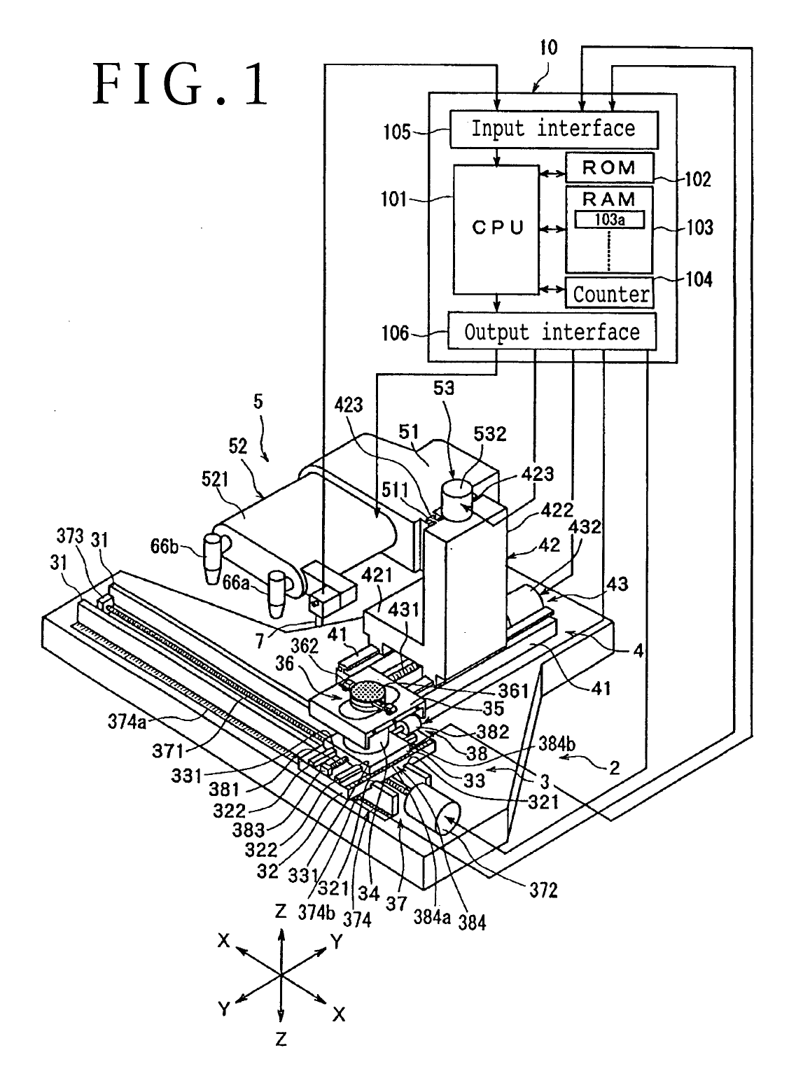

Preferred embodiments of a laser processing machine configured according to the present invention will hereinafter be described in detail with reference to the accompanying drawings. FIG. 1 is a perspective view of the laser processing machine constructed according to the present invention. The laser processing machine shown in FIG. 1 includes a stationary base 2, a chuck table mechanism 3, a laser beam irradiation unit support mechanism 4 and a laser beam irradiation unit 5. The chuck table mechanism 3 is mounted to the stationary base 2 so as to be movable in a processing-transfer direction (an X-axial direction) indicated with arrow X and is adapted to hold a workpiece. The laser beam irradiation unit support mechanism 4 is mounted to the stationary base 2 so as to be movable in an indexing-transfer direction (a Y-axial direction) indicated with arrow Y perpendicular to the processing-transfer direction (the X-axial direction) indicated with arrow X. The laser beam irradiation unit 5 is mounted to the laser beam unit support mechanism 4 so as to be movable in a direction (a Z-axial direction) indicated with arrow Z.

The chuck table mechanism 3 includes a pair of guide rails 31, 31, a first slide block 32, a second slide block 33, and a cover table 35. The pair of guide rails 31, 31 is disposed on the stationary base 2 so as to be parallel to the processing-transfer direction (the X-axial direction) indicated with arrow X. The first slide block 32 is disposed on the guide rails 31, 31 so as to be movable in the processing-transfer direction (the X-axial direction) indicated with arrow X. The second slide block 33 is disposed on the first slide block 32 so as to be movable in the indexing-transfer direction (the Y-axial direction) indicated with arrow Y. The cover table 35 is disposed above the second slide block 33 and supported by a cylindrical member 34. The chuck table mechanism 3 further includes a chuck table 36 as workpiece-holding means. The chuck table 36 is provided with a suction chuck 361 which is formed of a porous material and is adapted to hold thereon e.g. a disklike semiconductor wafer, a workpiece, by suction means not shown. The chuck table 36 configured as above is rotated by a pulse motor not shown disposed in the cylindrical member 34. A clamp 362 is disposed on the chuck table 36 in order to secure an annular frame described later.

The first slide block 32 is provided on its lower surface with a pair of to-be-guided grooves 321, 321 fitted respectively to the pair of guide rails 31, 31 and on its upper surface with a pair of guide rails 322, 322 formed parallel to the indexing-transfer direction (the Y-axial direction) indicated with arrow Y. The first slide block 32 configured as above can be moved along the pair of guide rails 31, 31 in the processing-transfer direction (the X-axial direction) by the to-be-guided grooves 321, 321 being fitted respectively to the pair of guide rails 31, 31. The chuck table mechanism 3 of the embodiment shown in the figure is equipped with processing-transfer means 37 for moving the first slide block 32 along the pair of guide rails 31, 31 in the processing-transfer direction (the X-axial direction) indicated with arrow X.

The processing-transfer means 37 includes an external thread rod 371 disposed between and parallel to the pair of guide rails 31, 31 and a drive source such as a pulse motor 372 adapted to drivingly turn the external thread rod 371. One end of the external thread rod 371 is turnably supported by a bearing block 373 secured to the stationary base 2 and the other end is transferably connected to the output shaft of the pulse motor 372. Incidentally, the external thread rod 371 is threadedly engaged with an internal thread through-hole formed in an internal screw block not shown provided to project from a central lower surface of the first slide block 32. Thus, the first slide block 32 is moved along the guide rails 31, 31 in the processing-transfer direction (the X-axial direction) indicated with arrow X by normally and reversely turning the external thread rod 371 by the pulse motor 372.

The laser processing machine of the present invention shown in the figure is provided with processing-transfer amount detecting means 374 for detecting the processing-transfer amount of the chuck table 36. The processing-transfer amount detecting means 374 includes linear scale 374a disposed along the guide rail 31 and a read head 374b attached to the first slide block 32 so as to move together with the first slide block 32 along the linear scale 374a. The read head 374b of the transfer amount detecting means 374 sends a pulse signal of one pulse for each 1 μm to control means described later in the embodiment shown in the figure. The control means detects the processing-transfer amount of the chuck table 36 by counting pulse signals inputted thereto.

If the pulse motor 372 is used as the drive source for the processing-transfer means 37, the control means can detect the processing-transfer amount of the chuck table 36 by counting the drive pulses of the control means described later which outputs a drive signal to the pulse motor 372. If a servo motor is used as the drive source for the processing-transfer means 37, the control means described later can detect the processing-transfer amount of the chuck table 36 by receiving and counting pulse signals outputted thereto by a rotary encoder detecting the rotation number of the servo motor.

The second slide block 33 is provided on its lower surface with a pair of to-be-guided grooves 331, 331 fitted respectively to the pair of guide rails 322, 322 provided on the upper surface of the first slide block 32. The second slide block 33 can be moved in the indexing-transfer direction (the Y-axial direction) indicated with arrow Y by fitting the respective to-be-guided grooves 331, 331 to the pair of guide rails 322, 322. The chuck table mechanism 3 is equipped with first indexing-transfer means 38 which moves the second slide block 33 in the indexing-transfer direction (the Y-axial direction) indicated with arrow Y along the pair of guide rails 322, 322 provided on the first slide block 32.

The first indexing-transfer means 38 includes an external thread rod 381 disposed between and parallel to the pair of guide rails 322, 322 and a drive source such as a pulse motor 382 adapted to drivingly turn the external thread rod 381. One end of the external thread rod 381 is turnably supported by a bearing block 383 secured to the upper surface of the first slide block 32 and the other end is transferably connected to the output shaft of the pulse motor 382. Incidentally, the external thread rod 381 is threadedly engaged with an internal thread through-hole formed in an internal screw block not shown provided to project from a central lower surface of the second slide block 33. Thus, the second slide block 33 is moved along the guide rails 322, 322 in the indexing-transfer direction (the Y-axial direction) indicated with arrow Y by normally and reversely turning the external thread rod 381 by the pulse motor 382.

The laser processing machine of the present embodiment is provided with indexing-transfer amount detecting means 384 for detecting the indexing-transfer amount of the second slide block 33. The indexing-transfer amount detecting means 384 includes linear scale 384a disposed along the guide rail 322 and a read head 384b attached to the second slide block 33 so as to move together with the second slide block 32 along the linear scale 384a. The read head 384b of the transfer amount detecting means 384 sends a pulse signal of one pulse for each 1 μm to the control means described later in the embodiment. The control means detects the indexing-transfer amount of the chuck table 36 by counting pulse signals inputted thereto.

If the pulse motor 382 is used as the drive source for the indexing-transfer means 38, the control means can detect the indexing-transfer amount of the chuck table 36 by counting the drive pulses of the control means described later which outputs a drive signal to the pulse motor 382. If a servo motor is used as the drive source for the first indexing-transfer means 38, the control means described later can detect the indexing-transfer amount of the chuck table 36 by receiving and counting pulse signals outputted thereto by a rotary encoder detecting the rotation number of the servo motor.

The laser beam irradiation unit support mechanism 4 includes a pair of guide rails 41, 41 disposed on the stationary base 2 so as to be parallel to and along the indexing-transfer direction (the Y-axial direction) indicated with arrow Y; and a movable support base 42 disposed on the guide rails 41, 41 to be movable in a direction indicated with arrow Y. The movable support base 42 includes a moving support portion 421 movably disposed on the guide rails 41, 41; and an attachment portion 422 attached to the moving support portion 421. The attachment portion 422 is provided on its lateral surface with a pair of guide rails 423, 423 parallelly extending in the direction (the Z-axial direction) indicated with arrow Z. The laser beam irradiation unit support mechanism 4 is equipped with a second indexing-transfer means 43 for moving the movable support base 42 along the pair of guide rails 41, 41 in the indexing-transfer direction (the Y-axial direction) indicated with arrow Y.

The second indexing-transfer means 43 includes an external thread rod 431 disposed between and parallel to the pair of guide rails 41, 41 and a drive source such as a pulse motor 432 adapted to drivingly turn the external thread rod 431. One end of the external thread rod 431 is turnably supported by a bearing block not shown secured to the stationary base 2 and the other end is transferably connected to the output shaft of the pulse motor 432. Incidentally, the external thread rod 431 is threadedly engaged with an internal thread hole formed in an internal screw block not shown provided to project from a central lower surface of the moving support portion 421 constituting part of the movable support base 42. Thus, the movable support base 42 is moved along the guide rails 41, 41 in the indexing-transfer direction (the Y-axial direction) indicated with arrow Y by normally and reversely turning the external thread rod 431 by the pulse motor 432.

The laser beam irradiation unit 5 is equipped with a unit holder 51 and with laser beam irradiation means 52 attached to the unit holder 51. The unit holder 51 is provided with a pair of to-be-guided grooves 511, 511 slidably fitted to the pair of guide rails 423, 423 provided on the attachment portion 422. The unit holder 51 is supported movably in a direction (the Z-axial direction) indicated with arrow Z by fitting the respective to-be-guided grooves 511, 511 to the guide rails 423, 423.

The laser beam irradiation unit 5 is equipped with moving means (light focusing point positioning means) 53 for moving the unit holder 51 along the pair of guide rails 423, 423 in the direction (the Z-axial direction: the direction vertical to a holding surface which is the upper surface of the suction chuck 361) indicated with arrow Z. The moving means 53 includes an external thread rod (not shown) disposed between the pair of guide rails 423, 423; and a drive source such as a pulse motor 532 or the like for drivingly turning the external thread rod. The moving means 53 moves the unit holder 51 and the laser beam irradiation means 52 along the guide rails 423, 423 in the direction (the Z-axial direction) indicated with arrow Z by normally or reversely driving the external thread rod not shown by the pulse motor 532. Incidentally, in the embodiment shown in the figure, the laser beam irradiation means 52 is moved upward by normally turning the pulse motor 532 and downward by reversely turning the pulse motor 532.

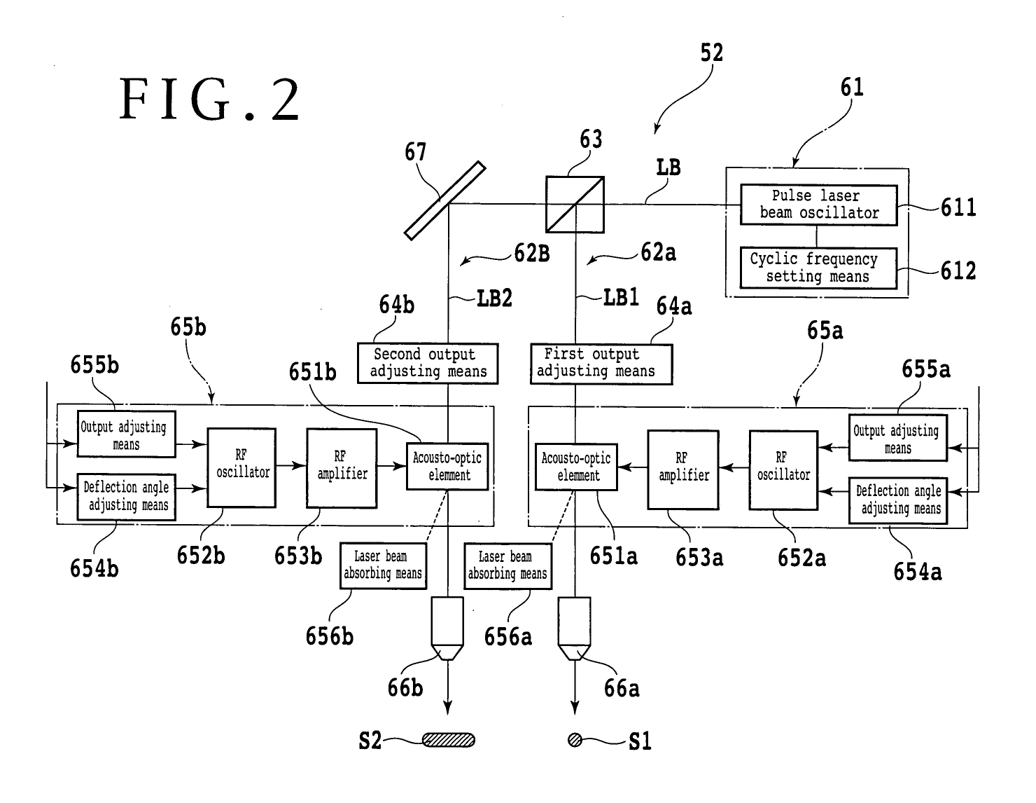

The laser beam irradiation means 52 includes a substantially horizontally arranged casing 521 in which pulse laser beam oscillating means 61 is disposed as shown in FIG. 2. A pulse laser beam LB emitted from the pulse laser beam oscillating means 61 is split into a first pulse laser beam LB1 and a second pulse laser LB2 propagating along a first path 62a and a second path 62b, respectively. The first pulse laser beam LB1 propagating along the first path 62a is collected by a first condenser 66a through a first output adjusting means 64a and a first acousto-optic deflection means 65a. On the other hand, the second pulse laser beam LB2 propagating along the second path 62b is collected by a second condenser 66b through a direction converting mirror 67, a second output adjusting means 64b and a second acousto-optic deflection means 65b.

The pulse laser beam oscillating means 61 includes a pulse laser beam oscillator 61 and cyclic frequency setting means 612 attached to the pulse laser beam oscillator 61. The pulse laser beam oscillator 611 is composed of a YVO4 laser or YAG laser oscillator in the embodiment shown in the figure and emits a pulse laser beam LB set by the cyclic frequency setting means 612. The beam splitter 63 splits, at the same ratio, the pulse laser beam LB emitted from the pulse laser oscillation means 61 into the first pulse laser beam LB1 and the second pulse laser beam LB2 propagating the first path 62a and the second path 62b, respectively. The first output adjusting means 64a and the second output adjusting means 64b adjust the first pulse laser beam LB1 and second pulse laser beam LB2 at respective desired outputs.

The first acousto-optic deflection means 65a and the second acousto-optic deflection means 65b respectively include acousto-optic elements 651a and 651b; RF oscillators 652a and 652b; RF amplifiers 653a and 653b; deflection angle adjusting means 654a and 654b; output adjustment means 655a and 655b. The acousto-optic elements 651a and 651b deflect the first pulse laser beam LB1 propagating the first path 62a and the second pulse laser beam LB2 propagating the second path 62b, respectively, the first and second pulse laser beams LB1 and LB2 resulting from the pulse laser beam split by the beam splitter 63. The RF oscillators 652a and 652b create RF (radio frequency) applied to the acousto-optic elements 651a and 651b, respectively. The RF amplifiers 653a and 653b amplify the power of RF created by the RF oscillators 652a and 652b and apply the power thus amplified to the acousto-optic elements 651a and 651b, respectively. The deflection angle adjusting means 654a and 654b adjust the RF created by the RF oscillators 652a and 652b, respectively. The output adjusting means 655a and 655b adjust the amplitude of the RF created by the RF oscillators 652a and 652b, respectively.

The acousto-optic elements 651a and 651b can each adjust the deflection angle of the laser beam in accordance with the RF applied thereto and also adjust the power of the laser beam in accordance with the amplitude of the RF applied thereto. Incidentally, the deflection angle adjusting means 654a and 654b and the output adjusting means 655a and 655b are controlled by control means not shown. In the first acousto-optic deflection means 65a configured as above, if a voltage of e.g. 10 V is applied to the first deflection adjusting means 654a and the RF according to 10 V is applied to the acousto-optic element 651a, the first pulse laser beam LB1 is led to the first condenser 66a as indicated with a solid line in FIG. 2. Similarly, in the second acousto-optic deflection means 65b configured as above, if a voltage of e.g. 10 V is applied to the second deflection adjusting means 654b and the RF according to 10 V is applied to the acousto-optic element 651b, the second pulse laser beam LB2 is led to the second condenser 66b as indicated with a solid line in FIG. 2. If a voltage of 0 V is applied to the deflection angle adjusting means 654a and the RF according to 0 V is applied to the acousto-optic element 651a, the first laser beam LB1 is led to laser beam absorbing means 656a as indicated with a broken line in FIG. 2. Similarly, if a voltage of 0 V is applied to the deflection angle adjusting means 654b and the RF according to 0 V is applied to the acousto-optic element 651b, the second laser beam LB2 is led to laser beam absorbing means 656b as indicated with a broken line in FIG. 2.

The first condenser 66a and second condenser 66b are attached to the end of the casing 521 as shown in FIG. 1. The first condenser 66a is configured to focus the first pulse laser beam LB1 on a circular spot S1 as shown in FIG. 2 in the present embodiment. The second condenser 66b is configured to focus the second pulse laser beam LB2 on an oval spot S2 as shown in FIG. 2 in the present embodiment. Incidentally, a cylindrical lens or a mask member having an oval opening can be used as means for shaping the focusing spot of the laser beam into an oval.

The description is continued with reference to FIG. 1. Imaging means 7 for detecting a processing area to be laser-processed by the laser beam irradiation means 52 is attached to the leading end of the casing 521 constituting part of the laser beam irradiation means 52. The imaging means 7 includes infrared illumination means for emitting an infrared ray to a workpiece, an optical system for capturing the infrared ray emitted by the infrared illumination means, and an image pickup device (an infrared CCD) outputting an electric signal corresponding to the infrared ray captured by the optical system as well as a usual image pickup device (CCD) taking an image with a visible ray. The imaging means 7 sends the imaged picture signal to the control means described later.

The laser processing machine of the present embodiment is equipped with control means 10, which is composed of a computer. The control means 10 includes a central processing unit (CPU) 101 which performs arithmetic processing according to a control program; a read-only memory (ROM) 102 for storing the control program and the like; a readable and writable random access memory (RAM) 103 for storing calculation results and the like; a counter 104; an input interface 105; and an output interface 106. The input interface 105 of the control means 10 is adapted to receive detection signals from the processing-transfer detection means 374, the indexing-transfer detection means 384, the imaging means 7 and the like. The output interface 106 of the control means 10 is adapted to output control signals to the pulse motor 373, the pulse motor 382, the pulse motor 432, the pulse motor 532, the pulse laser beam oscillation means 61 of the pulse laser beam oscillation means 52, the respective deflection angle adjusting means 654a and 654b and the respective output adjusting means 655a and 655b of the first and second acousto-optic deflection means 65a and 65b. Incidentally, the random access memory (RAM) 103 is provided with a first memory area 103a and with other memory areas for storing the data of designed values of a workpiece described later.

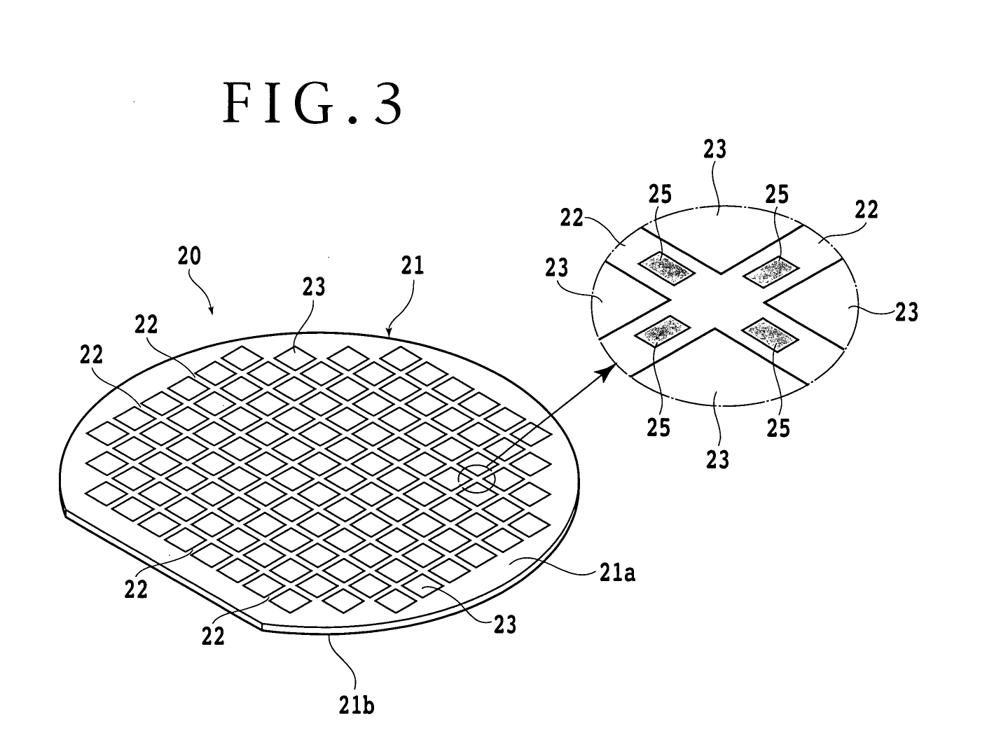

The laser processing machine of the present embodiment is configured as above. The operation of the laser processing machine will be described below. FIG. 3 is a perspective view illustrating a semiconductor wafer as a workpiece. A semiconductor wafer 20 shown in FIG. 3 is formed with a plurality of areas sectioned by a plurality of streets 22 arranged in a lattice-like pattern on the front surface 21a of a silicon substrate 21 and a device 23 such as an IC, a LSI or the like is formed on each of the areas. The semiconductor wafer 20 is partially formed on the streets 22 with test-purpose metal patterns 25 called test element groups (TEG) used to test the functions of the devices 23. Incidentally, the metal pattern 25 is made of copper in the embodiment. The design coordinate values of the positions associated with the streets 22 and metal patterns 25 of the semiconductor wafer 20 configured as above are stored in the first memory area 103a of the random access memory (RAM) 103 in the control means 10.

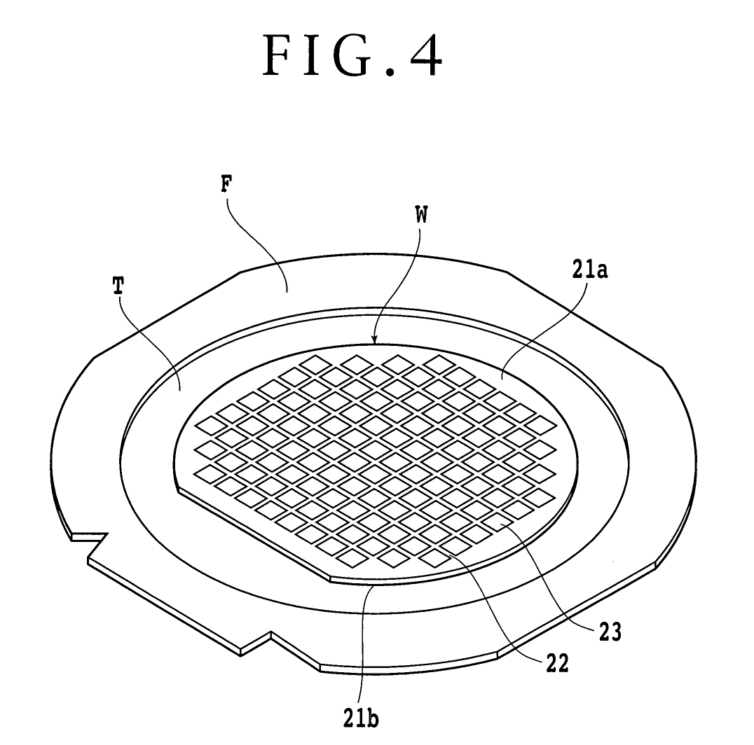

The semiconductor wafer 20 configured as above is such that a rear surface 21b of the silicon substrate 21 is stuck to a protection tape T composed of a synthetic resin sheet made of such as polyolefin or the like attached to an annular frame F shown in FIG. 4. The semiconductor wafer 20 is such that a front surface 21a of the silicon substrate 21 faces upward. In this way, the semiconductor wafer W supported by the annular frame F via the protection tape T is placed on the chuck table 36 of the laser processing machine shown in FIG. 1 with the side of the protection tape T placed on the chuck table 36. The semiconductor wafer 20 is sucked and held onto the chuck table 36 via the protection tape T by actuating suction means not shown. The annular frame F is secured by the clamp 362.

The chuck table 36 sucking and holding the semiconductor wafer 20 as described above is positioned immediately below the imaging means 7 by the processing-transfer means 37. After the chuck table 36 is positioned immediately below the imaging means 7, alignment operation is performed in which the imaging means 7 and control means 10 detect a processing area of the semiconductor wafer 20 to be laser-processed. Specifically, the imaging means 7 and control means 10 perform picture processing such as pattern matching and the like for alignment between the street 22 formed in the semiconductor wafer 20 to extend in a predetermined direction and the first and second condensers 66a and 66b of the laser beam irradiation means 52 for emitting a laser beam along the street 22. Thus, the alignment for the laser beam irradiation position is executed. Similarly, the alignment for the laser beam irradiation position is performed on the street 22 formed on the semiconductor wafer 20 to extend in a direction perpendicular to the predetermined direction.

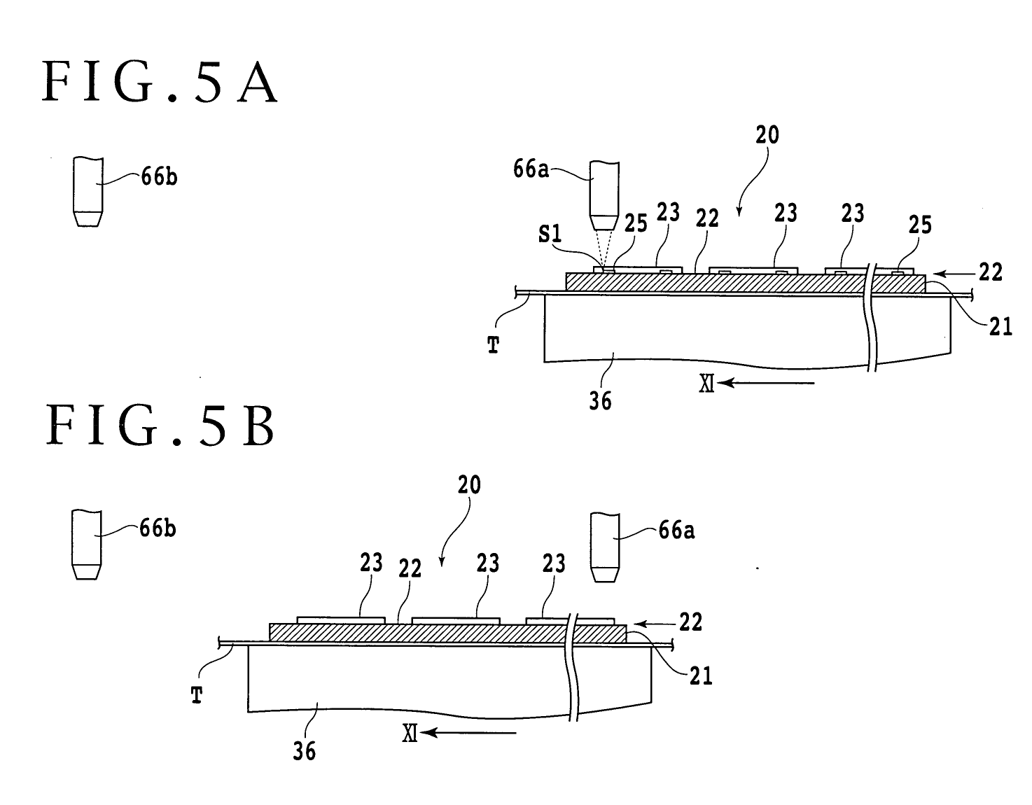

As described above, the street 21 formed on the semiconductor wafer 20 held on the chuck table 36 is detected and the alignment for the laser beam irradiation position is performed. Thereafter, the chuck table 36 is moved to a laser beam irradiation area where the first condenser 66a is located as shown in FIG. 5A. In addition, one end (the left end in FIG. 5A) of the leftmost metal pattern 25, in FIG. 5A, of the metal patterns 25 arranged on the predetermined street 21 formed on the semiconductor wafer 20 held by the chuck table 36 is positioned immediately below the first condenser 66a.

Next, the pulse laser beam oscillation means 61 of the laser beam irradiation means 52 shown in FIG. 2 emits a pulse laser beam LB with a wavelength (e.g. 355 nm) having absorbency for the semiconductor wafer 10. At this time, for example, a voltage of 10 V is applied to the deflection angle adjusting means 654a of the first acousto-optic deflection means 65a and the RF according to 10 V is applied to the acousto-optic element 651a. On the other hand, for example, a voltage of 0 V is applied to the deflection angle adjusting means 654b of the second acousto-optic deflection means 65b and the RF according to 0 V is applied to the acousto-optic element 651b. Consequently, the pulse laser beam LB emitted from the pulse laser beam oscillation means 61 is split into a first pulse laser beam LB1 propagating along the first path 62a and a second pulse laser beam LB2 propagating along the second path 62b. The first laser beam LB1 propagating along the first path 62a is emitted from the first condenser 66a via the first output adjusting means 64a and via the acousto-optic element 651a of the first acousto-optic deflection means 65a. Incidentally, the focusing point S1 of the pulse laser beam emitted from the first condenser 66a is made coincident with a position close to the surface of the metal pattern 25. On the other hand, the second pulse laser beam LB2 is led to the laser beam absorbing means 656b as shown with the broken line in FIG. 2.

While the pulse laser beam is emitted from the first condenser 66a as described above, the chuck table 36 is moved in a direction indicated with arrow X1 at a predetermined processing-transfer speed in FIG. 5A (a metal pattern removal step). When the other end (the right end in FIG. 5A) of the leftmost metal pattern 25 in FIG. 5A reaches a position immediately below the first condenser 66a, for example, a voltage of 0 V is applied to the deflection angle adjusting means 654a of the first acousto-optic deflection means 65a and the RF according to 0 V is applied to the acousto-optic element 651a. As a result, the first pulse laser beam LB1 is led to the laser beam absorbing means 656a as shown with the broken line in FIG. 2.

Further, the chuck table 36 is moved in a direction indicated with arrow X1 in FIG. 5A, so that one end (the left end in FIG. 5A) of the second metal pattern 25 from the leftmost end one of the metal patterns 25 in FIG. 5A reaches a position immediately below the first condenser 66a. At this time, for example, a voltage of 10 V is applied to the deflection angle adjusting means 654a of the first acousto-optic deflection means 65a to perform the metal pattern removal step as described above. In this way, the other end (the right end in FIG. 5A) of the leftmost metal pattern 25 of the metal patterns 25 arranged on the predetermined street 21 formed on the semiconductor wafer 20 in FIG. 5A reaches a position immediately below the first condenser 66a. At this time, all the metal patterns 25 formed on the street are removed as shown in FIG. 5B. This metal pattern removal step is performed by the first condenser 66a providing the circular focusing spot S1 high in light focusing density; therefore, the metal patterns 25 can reliably be removed.

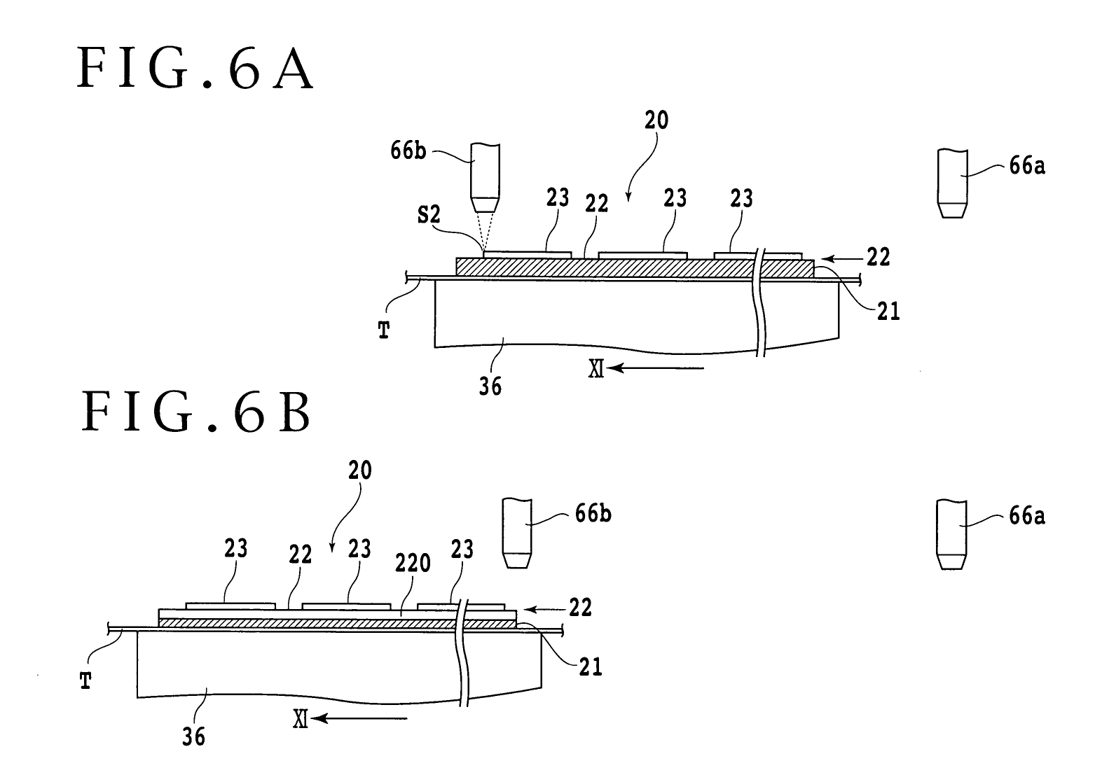

After the metal pattern removal step described above is finished, the chuck table 36 is further moved in the direction indicated with arrow X1 in FIG. 5B, so that one end (the left end in FIG. 6A) of the street 21 shown FIG. 6A reaches a position immediately below the second condenser 66b. At this time, for example, a voltage of 10 V is applied to the deflection angle adjusting means 654b of the second acousto-optic deflection means 65b and the RF according to 10 V is applied to the acousto-optic element 651b. Consequently, the second pulse laser beam LB2 propagating along the second path 62b is emitted from the second condenser 66b via the second output adjusting means 64b and via the acousto-optic element 651b of the second acousto-optic deflection means 65b. In this way, while the pulse laser beam is emitted from the second condenser 66b, the chuck table 36 is moved in the direction indicated with arrow X1 in FIG. 6A at a predetermined processing-transfer speed (the laser processing groove formation step). The other end (the right end In FIG. 6B) of the street 21 formed on the semiconductor wafer 20 held by the chuck table 36 as shown in FIG. 6B. At this time, for example, a voltage of 0 V is applied to deflection angle adjusting means 654b of the second acousto-optic deflection means 65b and the RF according to 0 V is applied to the acousto-optic element 651b. As a result, the second pulse laser beam LB2 is led to the laser beam absorbing means 656b as indicated with the broken line in FIG. 2.

In the laser processing groove formation step described above, the focusing point S2 of the pulse laser beam emitted from the second condenser 66b is made coincident with a position close to the surface of the street 21. In this way, by performing the laser processing groove formation step, a laser processing groove 220 is formed along the street 21 as shown in FIG. 6B on the semiconductor wafer 20 held by the chuck table 36. This laser processing groove formation step is performed by the second condenser 66b providing the oval focusing spot S2 large in overlap ratio. Therefore, the laser processing groove 220 can be formed to have a smooth wall surface. The metal pattern removal step and laser processing groove formation step described above are performed on all the streets 21 of the semiconductor wafer 20.

As described above, according to the laser processing machine of the embodiment shown in the figures, the laser beam irradiation means 52 provided with the single pulse laser beam oscillation means 61 can perform the processing by the circular focusing spot S1 emitted from the first condenser 66a and the processing by the oval focusing spot S2 emitted from the second condenser 66b. Thus, the two kinds of laser processing can be performed without use of two expensive laser oscillators.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing machine comprising:
a chuck table adapted to hold a workpiece; and
laser beam irradiation means for emitting a laser beam to the workpiece held by the chuck table;
wherein said laser beam irradiation means includes:
single laser beam oscillating means for emitting a laser beam;
a beam splitter which splits the laser beam emitted from the laser beam oscillating means into a first laser beam propagating along a first path and a second laser beam propagating along a second path;
a first condenser which condenses the first laser beam; and
a second condenser which condenses the second laser beam.

2. The laser processing machine according to claim 1, wherein said laser beam irradiation means further includes a first acousto-optic deflection means for deflecting the first laser beam disposed in the first path and a second acousto-optic deflection means for deflecting the second laser beam disposed in the second path.

3. The laser processing machine according to claim 1, wherein a spot on which the first laser beam is focused by the first condenser is different in shape from a spot on which the second laser beam is focused by the second condenser.
